(19) United States
(12) Patent Application Publication
(10) Pub. No.: US 2024/0251724 A1
(43) Pub. Date: Aug. 1, 2024

(54) Hydro Aero Pot

(71) Applicant: Chandana Vindika Kumara Lokunarangodage, Brampton (CA)

(72) Inventor: Chandana Vindika Kumara Lokunarangodage, Brampton (CA)

(21) Appl. No.: 18/161,147

(22) Filed: Jan. 30, 2023

(51) Int. Cl. A01G 31/02

(52) U.S. Cl. CPC A01G 31/02

(57) ABSTRACT

The present disclosure relates to a hybrid plant container assembly, which may configure with at least one sidewall characterized by a collection tank underneath a plurality of hollow pins with a porous base plate, mounted on top of a reservoir tank characterized by a test port for growing horticultural plants that are having high coercion for nutrients and oxygen. The hollow pins were configured to create a waterfall effect on draining water through the sidewall to increase the oxygen content, which is collected back through the collection tank located below. The plant pot represents hybrid functions of hydroponics, aeroponics, and conventional pots, wherein the hydro aero pot provides sufficient air pruning, oxygen, and uninterrupted nutrient supply through submerged root growth from the gravity-fed water collected in the reservoir tank to achieve multi-functional effects. The test port configured for manual or automated monitoring, while drainage and overflow outlets provide adequate maintenance.

### FIELD OF THE INVENTION

The present invention generally relates to the field of horticulture, and more particularly, the present disclosure relates to a hybrid plant container assembly.

### BACKGROUND OF THE INVENTION

Plant pots are a human invention commonly used to grow plants in environments, where the natural occurrence of plants is insupportable, or for commercial, or ornamental purposes. Thus, traditional plant pots are necessary to design with options for the supply of sufficient air, water, and nutrition continuously in order to get the optimum results from the plant growing in the pot as it consistently absorbs such requirements through the substrate. Hence, potted plants are required to be frequently cared for and watered, in order to thrive in hostile or modified environments, which is not an easy task. Subsequently, plant pots become a popular utensil throughout history and there are various innovations had been introduced over time, which is desirable to have improvements to the plant pots as agriculture evolves further into the future.

Plant growth is highly influenced by the development of a healthy root system, which in return provides faster growth and increases productivity, by absorbing water-soluble nutrients and oxygen, thus providing an uninterrupted supply of major nutrients from the extended root system. Hence, there are various references available for improved plant pots such as U.S. Pat. Nos. 4,442,628, 4,497,132, and 4,939,865 (Carl E. Whitcomb, Stillwater, Apr. 17, 1984, Feb. 5, 1985, and Jul. 10, 1990), that discuss the improvements in air pruning of roots, which further improved in the later developments such as U. S. Pub. US2009/01994.71 A1 (Single et al., Aug. 13, 2009) improving the reduction of circular roots, but use to have disadvantages like water spillover and chemical/nutrient leachate from the substrate to the external environment.

Nonetheless, U.S. Pat. No. 4,716,680 (Whitcomb et al., Jan. 5, 1988), U. S. Pub. US2014/0173982 A1 (KAKU LU, Jun. 26, 2014) have introduced improved mouldable pot assemblies for the elimination of circular root growth wherein plants are intended to be transplanted.

Further, U.S. Pat. US262379 (E. K. Dean, Aug. 8, 1882), International Pub. WO 00/5939 (Van Den Ende et al., Feb. 10, 2000), U. S. Pub. US 2019/0200538 A1 (Middleton, Jul. 4, 2019), and several others discuss various designs of plant containers that include the water reservoir within the plant pot for continuous water supply or main application as hydroponic uses with their own merits and demerits.

Nonetheless, all the prior arts have contributed to improving the plant pot design and industrial usage, even though the objects of the prior arts are different from one another. However, more improvements are required as indoor growing needs more competitive designs as high-value crops are grown, where the healthy root system is a core necessity for uninterrupted nutrient supply while achieving higher yields under high-intensity growing environments. Horticultural plants that are having high coercion for nutrients have a high oxygen demand for faster growth of root systems, whereas conventional pot has failed to address the issue except for hydroponics or aero-phonic designs. Nonetheless, root washing for the removal of fertilizer residues and cleaning of the harmful chemicals or cations/anion complexes buildup in the substrate is gaining popularity as it is required under high-intensity growing, but available solutions do not adequately comply with such requirements.

Further to that, the development of odour/flavour compounds, resin production, essential oils, wax, gum, etc. may be triggered by changing the temperature of the substrate. But soil or soilless substrate temperature in conventional pots is changed at a very slow rate, whereas hydroponic systems provide more efficient results due to the ability to amend the water temperatures at a rapid rate for imitating the fall conditions under such requirements, thus conventional pots have lower favourability in the market for such operations.

As many advanced production processes are becoming mostly fully automated, or semi-automated, meaning most of the monitoring and maintenance operations continue to be upgrading towards remote monitoring based on sensors, where current designs are not complying with such requirements adequately.

### BRIEF SUMMARY OF THE INVENTION

The object of the present invention is to provide an improved plant pot, which has a mouldable structure with a plurality of upwardly extending sidewalls 110, a porous base plate 120, and a reservoir tank 130, wherein a basic locking mechanism configured that is generally available to the public may work in conjunction with the sidewall 110, the porous base plate 120, and the reservoir tank 130 for stronger assembly of the hydro aero pot 100.

Another object of the present invention is to provide a planting pot having hybrid functions of hydroponics, aeroponics, and conventional pots, with a realistic design to provide convenience in assembly, disassembly, storage, transportation, cleaning, and disinfection. Thus, the hydro aero pot 100 provides sufficient air pruning, oxygen for the growth of root system, hydroponic or submerged root growth, and uninterrupted nutrient supply from the gravity-fed water collected in the reservoir tank 130 for growing horticultural plants that are having high coercion for nutrients and oxygen (e.g., Cannabis), according to the present invention. Further, the gravity-fed water seeped through the substrate may self-aerate before being collected back to the reservoir tank 130 to improve multi-functional effects. Hence, the sidewalls 110, the porous base plate 120, and the reservoir tank 130 may be cleaned and disinfected after disassembly before storage or reuse, where disassembly reduces the space required for storage and transportation.

Another object of the present invention is to provide an improved plant container for growing a plant intended to be root washed in the latter part of the life cycle for the removal of excess fertilizer or added chemicals, whereby collection and accumulation of leached such chemicals, and wastage of large quantities of water may be prevented, collected, and removed for recycling and reuse.

Consistent with further embodiments of the present invention, the sidewall 110 comprised of a top edge 905, an exterior surface 910, the connection legs 915, a collection tank 920, a slot open 925 inside the collection tank 920, a plurality of hollow pins 930 with an oblique cut 935 across an aperture 940, and a vertical cut 945 on the far end of the hollow pin 930. The exterior surface 910 of the sidewall 110 also preferably includes an inwardly opened connection slot 950 in each corner with an angular wall 955 wherein at least one slot opening 960 may make from that angular wall 955 through a beveled connection edge 965 on each connection slot 950.

In further preferred embodiments, the sidewall 110 has an interior surface 1005 facing the substrate, a beveled side edge 1010 similarly configured on both right and left sides, a lower flat edge 1015, and a beveled connection edge 1020 similar to the beveled connection edge 965 of the connection slot 950 on both sides of the beveled side edge 1010. The interior surface 1005 of the sidewall 110, preferably comprised of a plurality of gutters 1025 that may configure around a plurality of openings 1030, which represent the interior open end of the aperture 940 of the hollow pin 930. In one embodiment, the connection leg 915 of the sidewall 110 includes a slot opening 1035 on the connection leg 915.

In another preferred embodiment, the upper part of the hydro aero pot assembly 100 is comprised of a plurality of upwardly extended sidewalls 110. The multitude of top edges 905 of the sidewall 110 connects each other to form the open top of the upper chamber, while the vertically aligned sidewall 110 connects each other to form the body of the upper chamber of the hydro aero pot 100.

In a preferred embodiment, the lower end of the beveled connection edge 965 of the sidewall 110 may extend outwardly to form the connection leg 915 that may interlock with the porous base plate 110 and the underneath reservoir tank 130. Preferably, the porous base plate 120 may push against connection legs 915 of the sidewall 110, on configured openings of the porous base plate 120 to form the bottom for the upper chamber of the hydro aero pot 100. The connection legs 915 may be further inserted against additionally configured openings on the reservoir tank 130 for complete assembly of the hydro aero pot 100.

Alternatively or in addition, the sidewall 110 is configured to have the slot open 925 along the lower edge 1015, along the horizontal plane through to the interior surface 1005 of the sidewall 110. The exterior surface 910 of the sidewall 110 further includes the outwardly extending collection tank 920 under the hollow pins to collect the drained-off water back to the pot through the slot open 925 made inside the collection tank 920 of the sidewall 110.

In one embodiment, the plurality of hollow pins 930 substantially covers the exterior surface 910 of the sidewall 110 in the middle area, which may be outwardly extended recesses/hollow pins 930 with apertures 940 that may cut in an angle to the horizontal plane as the oblique cut 935 and the vertical cut 945 across the aperture 940 in the middle on the vertical plane. Preferably, both cuts may configure to create a waterfall effect by breaking the water stream into small droplets in the gravity-fed water stream inside the hollow pin 930 that is subtracted from the substrate before coming out of the aperture 940. The hollow pins 930 may be extended outwardly straight, tapering, or as a downwardly extended bend at the end. The vertical cut 945 in the middle of the aperture 940 makes sure to eliminate the disadvantage of water spraying out of the pot by breaking of water stream before leaving the aperture 940 and collecting back through the hollow pin 930 to the collection tank 920 of the sidewall 110, which is a common disadvantage of a most of the prior arts introduced with apertures and recesses. The breaking of the incoming water stream into small water droplets further creates an opportunity to mix up water droplets with air while falling down through hollow pins 930 to provide oxygen to the water collected back in the reservoir tank 130 for further use in the development of a submerged root system.

Preferably in one embodiment, each corner and the beveled side edge 1010 of the sidewall 110 may configure to include the inwardly opened connection slot 950 with the angular wall 955 that holds the plurality of slot openings 960, which may be made from the angular wall 955 through to the beveled connection edge 965 on each connection slot 950. The interior angular wall 955 of the connection slot 950 may parallel to the beveled side edge 1010.

Preferably, the sidewall 110 includes the interior surface 1005, where both the right and the left side edges of the sidewall 110 also include the vertically extended beveled side edges 1010 on an acute angle to the horizontal plane. The beveled sided edges 1010 may further configure to include the beveled connection edge 1020 on both sides, which is the back side of the connection slots 950 that provides additional support, where the sidewalls 110 have configured to be connected to each other on top of the porous base plate 120 to form the upper chamber with an open top. The beveled side edge 1010 of the sidewalls 110 may configure to be further tightened using generally available zip/cable ties 140 (or plastic rivets, string, nut and bolt, etc.) through upper, middle, and lower slot openings 960 of the connecting slots 950, and may be disconnected by cutting zip/cable ties 140 and pulling the sidewalls 110 outwardly apart.

The interior surface 1005 of the sidewall 110 preferably comprised of the plurality of gutters 1025 configured around the lower half of a plurality of apertures 1030 of the hollow pins 930 configured on the outer surface 910. Further, the aperture 1030 is the internal opening of aperture 940 of the hollow pin 930 of the side wall 110. Each of the gutters 1025 may inwardly extend towards the substrate inside the upper chamber of the hydro aero pot 100 for collecting water from the substrate material, while creating air pockets underneath and directing roots growing therein outwardly towards hollow pins 930 whereby, roots are exposed to the air and are air pruned.

Alternatively or in addition, the connection leg 915, may configure to include the slot opening 1035 in close proximity to the far end to tie up the connection leg 915 to the reservoir tank 130 strongly through porous base plate 120, in order to make assembly more convenient for the user.

Consistent with further embodiments of the present invention, the porous base plate 120 comprised of a solid surface 1105 around the porous area, a plurality of slot opening 1110 on the corners, a plurality of apertures 1115 on the middle area to create porosity, and an exterior edge 1120, which may be extended upwardly to configure a short periphery wall 1125. Preferably, the porous base plate 120 also may include one or more downwardly extended porous hollow cup 1130 with a cup wall 1135 up to the edge of the water level.

Preferably in another embodiment, the porous base plate 120 may also comprise a compacted rear surface 1205 around the porous area of the base plate 120. The porous hollow cup 1130 in the porous area of the base plate 120 includes a plurality of hollow cups with a porous bottom 1210 with a plurality of apertures 1215 for the porosity of the cup bottom 1210, where the cup wall 1135 may configure to include a plurality of vertical openings 1220 for further penetration of roots towards the water by the sides of the cup wall 1130 in addition to the porous bottom 1210.

Alternatively or in addition, each corner of the porous base plate 120 includes the slot opening 1110 for insertion of the connection legs 915, which allows the stronger assembly of the upper chamber of the hydro aero pot 100 that may cross-connected to the reservoir tank 130 below.

Preferably the porous base plate 120 may configure to tightly hold the lower edges 1015 of upwardly extended sidewalls 110 together against the short periphery wall 1125 around it. Hence, the sidewall 110 may configure to extend upwardly from inside of the periphery wall 1125 of the porous base plate 110 during the assembly.

In a preferred embodiment, the porous base plate 120 also includes one or more downwardly extended porous hollow cup 1130 with the porous bottom 1210, and the wall 1135 up to the edge of the water level of the reservoir tank 130 that alternatively acts as a self-watering embodiment due to the capillary action of the water through the substrate. Further, the roots extend beyond the porous hollow cup 1130 may enter the reservoir tank 130 and act as hydroponic roots, while providing continuous nutrient and water supply to the plant throughout the life cycle.

In a further preferred embodiment, the porous area of the base plate 120 acts as an air barrier to the roots, which further improves the air pruning of the roots that reach out of the porous base plate 120. The air pruning further increases the number of lateral root growth inside the upper chamber of the pot by promoting the creation of a plurality of lateral roots through the abatement of apical dominance.

Consistent with further embodiments of the present invention, the reservoir tank 130 comprised of an open top 1405, a plurality of sidewalls 1410, a compact bottom 1420, a plurality of snap fits 1425, on each corner with an opening 1430, to interlock with the upper chamber of the hydro aero pot 100, a plurality of slot openings 1435 for connectivity, a fair of handles 1440 on corresponding sidewalls 1410, a test port 1445 (water testing port), a drain off nipple 1450 and an overflow nipple 1455 with an aperture 1460 on each nipple to be connected to external collection lines.

In accordance with the present invention, the porous base plate 120 of the hydro aero pot 100, may mount on top of the reservoir tank 130 wherein the assembled sidewalls 110 (the upper chamber) may mount on top of the porous base plate 120 to form the base of the upper chamber. Preferably, the reservoir tank 130 may have the same dimensions as the porous base plate 120, wherein the connection legs 915 may cross-connect through the porous base plate 120 to the slot openings 1430 of the snap fit 1425 configured on each corner of the top edge 1415 of the reservoir tank 130. Further, the slot openings 1430 of snap fit 1425 provided on the corners of the top edge 1415 of the reservoir tank 130 may force against the connection legs 915 that are manually pushed to crossover the base plate into the slot openings 1430 of the reservoir tank 130 and zip/cable tied 140 to hold them together with the provided slot openings 1435 on each corner of the reservoir tank 130.

According to the present invention, the gravity-fed water may collect in the reservoir tank 130, which may aerate while descending through the sidewall hollow pins 930 or substrate. Thus, infiltrated water is rich in water-soluble nutrients and oxygen, which may provide an uninterrupted supply of major nutrients and water from the extended submerged root system inside the reservoir tank 130. The aeration takes place due to the waterfall effect on the sidewall hollow pins 930 also enriches the oxygen content in the water, which may minimize the degradation of roots in the water due to higher oxygen levels that promote uninterrupted root growth at submerged conditions.

Preferably, the test port 1445 may be an outwardly extended vertically aligned embodiment, which may configure on one corner of the outer perimeter of the top edge 1415 of the reservoir tank 130 with an open top 1465, at least one wall 1470 forming sides and a compact bottom. Preferably, the test port 1445 also has a slot opening 1505 through sidewall 1410 of the reservoir tank 130 configured on the lower end of the test port 1445 to keep the water connectivity uninterrupted to the water reservoir.

In accordance with the present invention, the drainage nipple 1450 and the overflow nipple 1455 may configure to any sidewall 1410 of the reservoir tank 130 includes apertures 1460, that may be an ordinary opening or even a hole, which may be plugged with a stopper, or it may comprise a tube or a nipple extending out of the sidewall 1410, where the aperture 1460 used for the flowing water out of the reservoir tank 130 may be clamped, capped or closed by any other means, to control the outflow of water from the reservoir tank 130. The nipple openings may also be detachably connected to exterior drainage tubes for the removal of excess water away from the reservoir tank 130 to an external collection vessel.

In a further preferred embodiment, the drain-off nipple 1450 may use to maintain the water quality inside the reservoir tank, which allows easy drain-off ability, if the water is polluted, or contaminated. Nonetheless, overflow nipple 1455 may keep the water level constant using aperture 1460, without direct contact of the water level and the lower part of the upper chamber, except the hollow cup 1130 on the porous base plate 120, to promote capillary action and hydroponic root growth.

In a further preferred embodiment, the pair of inwardly extended handles 1440 may embed into two of the opposite sidewalls 1410 in close proximity to the top edge 1415 of the reservoir tank 130 or, alternatively configure into any appropriate surface of the hydro aero pot 100 for the prime grip, easy handling, and moving while on field use. The handles 1440 may be an embedded close design to stop water spillage, or alternatively may be a slot open any other alternative with any shape and a convenient surface for a prime grip, while handling.

In a further preferred embodiment, the hydro aero pot 100 may configure with the detachable sidewalls 110, the detachable or perpetually connected collection tank 920, the detachable porous base plate 120, and the reservoir tank 130, or alternatively, the hydro aero pot 100 may configure with perpetually interconnected sidewalls 110, or as a single sidewall 110 to the reservoir tank 130 with a detachable porous base plate 120 and the detachable collection tank 920 according to the present invention. Preferably, the perpetually connected hydro aero pot may comprise of the sidewall 110 characterized by the open top 905, the collection tank 920, the hollow pin 930, the plurality of gutters 1025, the test port 1445, drain-off nipple 1450, overflow nipple 1455, and the apertures 1460 of the hydro aero pot 100, whereas the porous base plate 120 characterized by porous hollow cups 1130, with the plurality of apertures 1115, sit on a ledge lock 1705, which is a protuberance configured on the top edge of the reservoir tank 130 of the hydro aero pot 100.

### BRIEF DESCRIPTION OF THE DRAWINGS

The appended drawings contain figures of certain embodiments to further illustrate and clarify the above and other aspects, advantages, and features of the present invention. It will be appreciated that these drawings depict embodiments of the invention and are not intended to limit its scope. The invention will be described and explained with additional specificity and detail through the use of the accompanying drawings for a more complete understanding, where references are made to the following descriptions and accompanying drawings, in which:

FIG. 01 depicts a perspective view of a hydro aero pot after the assembly of prescribed embodiments together, according to the invention.

FIG. 02 depicts a plan view of an assembled hydro aero pot according to the invention.

FIG. 03 depicts a front view of an assembled hydro aero pot according to the invention.

FIG. 04 depicts a left side view of an assembled hydro aero pot according to the invention.

FIG. 05 depicts a right side view of an assembled hydro aero pot according to the invention.

FIG. 06 depicts a bottom view of an assembled hydro aero pot according to the invention.

FIG. 07 depicts a back view of an assembled hydro aero pot according to the invention.

FIG. 08 depicts a perspective exploded view of a hydro aero pot, which is ready for assembly in accordance with the invention.

FIG. 09 depicts a perspective front view of a sidewall of a hydro aero pot according to the invention.

FIG. 09(A) depicts a detailed view of a selected region from a perspective front view of a sidewall of a hydro aero pot according to the invention.

FIG. 09(B) depicts a detailed view of a selected region from a perspective front view of a sidewall of a hydro aero pot according to the invention.

FIG. 09(C) depicts a detailed view of a selected region from a perspective front view of a sidewall of a hydro aero pot according to the invention.

FIG. 10(a) depicts a perspective back view of a sidewall of a hydro aero pot according to the invention.

FIG. 10(A) depicts a detailed view of a selected region from a perspective back view of a sidewall of a hydro aero pot according to the invention.

FIG. 10(B) depicts a detailed view of a selected region from a perspective back view of a sidewall of a hydro aero pot according to the invention.

FIG. 10(C) depicts a detailed view of a selected region from a perspective back view of a sidewall of a hydro aero pot according to the invention.

FIG. 10(b) depicts a cross section of a sidewall across the lower end of a hydro aero pot according to the invention.

FIG. 10(c) depicts a cross-section of a sidewall across the middle of a hydro aero pot according to the invention.

FIG. 11 depicts a perspective top view of a porous base plate of a hydro aero pot according to the invention.

FIG. 12 depicts a perspective bottom view of a porous base plate of a hydro aero pot according to the invention.

FIG. 13 depicts a cross section of a perspective top view of a porous base plate of a hydro aero pot according to the invention.

FIG. 14 depicts a perspective view of a reservoir tank of a hydro aero pot according to the invention.

FIG. 14(A) depicts a detailed view of a selected region from a perspective view of a reservoir tank of a hydro aero pot according to the invention.

FIG. 14(B) depicts a detailed view of a selected region from a perspective view of a reservoir tank of a hydro aero pot according to the invention.

FIG. 15(a) depicts a cross section of a reservoir tank of a hydro aero pot according to the invention.

FIG. 15(b) depicts a perspective cross section view of a reservoir tank of a hydro aero pot according to the invention.

FIG. 16(a) depicts a front view of a cross section of an assembled hydro aero pot according to the invention.

FIG. 16(b) depicts a perspective view of a cross section of an assembled hydro aero pot according to the invention.

FIG. 17(a) depicts a perspective view of a hydro aero pot with a perpetually connected sidewall and a detachable porous base pate after assembly, according to the invention.

FIG. 17(b) depicts a front view of a cross-section of a hydro aero pot with a perpetually connected sidewall and a detachable porous base pate after assembly, according to the invention.

FIG. 17(c) depicts a plan view of a hydro aero pot with a perpetually connected sidewall and a detachable porous base pate after assembly, according to the invention.

### DETAILED DESCRIPTION OF THE INVENTION

The present invention will be disclosed using the preferred embodiments and appended drawings to provide a better understanding of the technical features, contents, impacts, and advantages of the present invention. However, the appended drawings are merely schematic representations, which may not be illustrated according to the actual scale and precise arrangement of the present invention, where the scope of protection of the present invention will not base on the scale and arrangement illustrated on the appended drawings and limited thereto.

The term “plant” includes any part, tissue, and organ originating from any plant, such as agricultural commercial, ornamental plants as well as the plant parts may include a fruit, a flower, a tuber, a root, a stem, a leaf, a seed, etc.

The term “water” does not necessarily mean pure water, which may include any liquid containing water or dilutions of nutrient solutions, organic brews, or municipal water, etc.

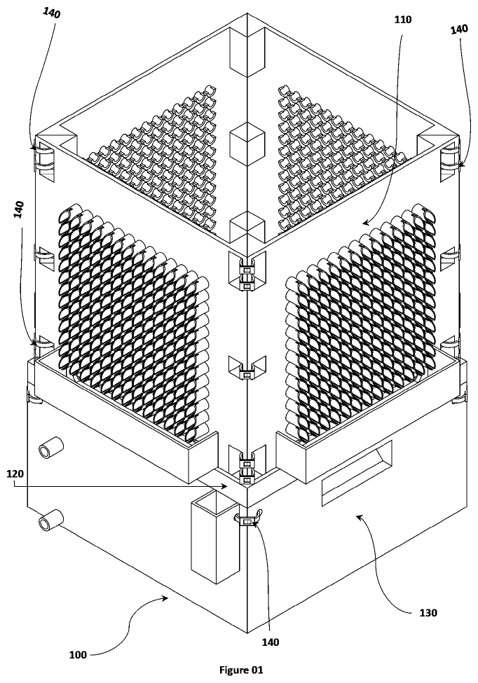

FIG. 01 depicts the front perspective view of an assembled hydro aero pot 100 according to the invention. The assembled hydro aero pot 100 includes at least a plurality of sidewalls 110, a base plate 120, and a reservoir tank 130, which may tie up together using generally available zip ties/cable ties (or plastic rivets, string, nut and bolt, etc.) 140. Further, the assembled hydro aero pot 100 contains two chambers, where the upper chamber may make by a plurality of porous sidewalls 110 assembled on top of a porous base plate 120, while the lower chamber is formed by the reservoir tank 130 underneath the base plate 120. The sidewall 110 may connect to the reservoir tank 130 through the porous base plate 120 using zip ties/cable ties 140, which hold them together as a single unit. Preferably, the sidewall 110 may be a moulded component, which may configure to replicate around the porous base plate 120 to build the upper chamber, where each face of the upper chamber is equally the same. Hence, one sidewall will be discussed during further descriptions.

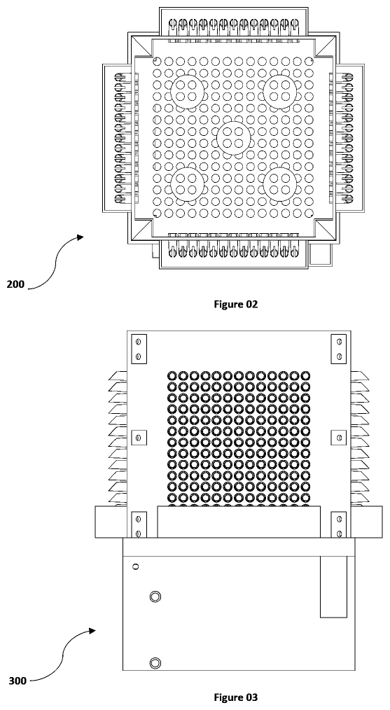

FIG. 02 depicts the plan view 200 of an assembled hydro aero pot 100 according to the invention.

FIG. 03 depicts the front view 300 of an assembled hydro aero pot 100 according to the invention.

FIG. 04 depicts the left view 400 of an assembled hydro aero pot 100 according to the invention.

FIG. 05 depicts the right view 500 of an assembled hydro aero pot 100 according to the invention.

FIG. 06 depicts the bottom view 600 of an assembled hydro aero pot 100 according to the invention.

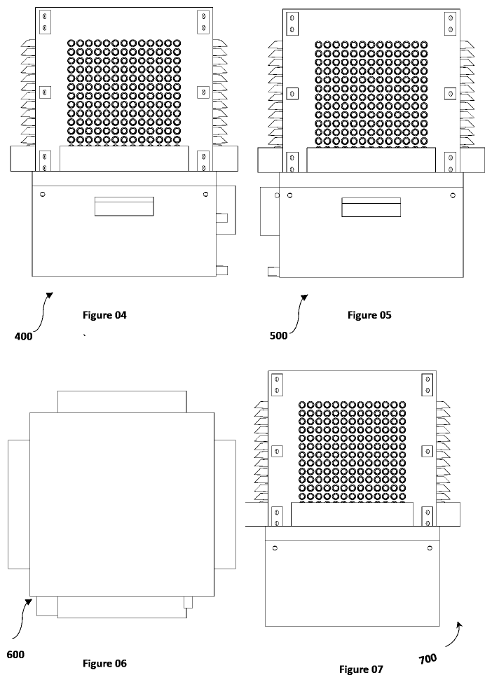

FIG. 07 depicts the back view 700 of an assembled hydro aero pot 100 according to the present invention.

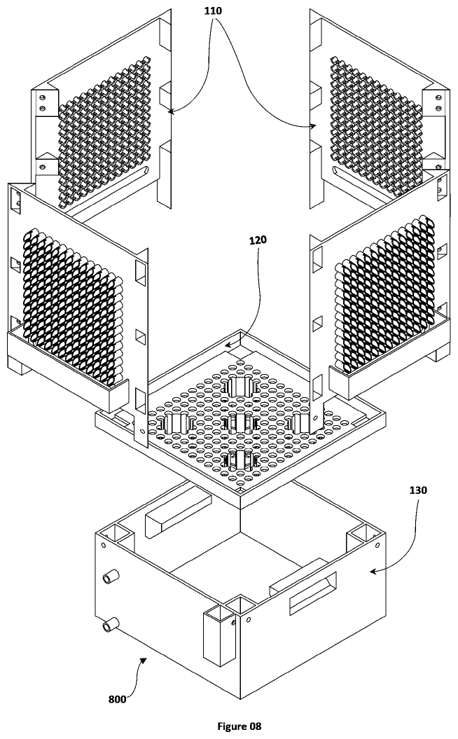

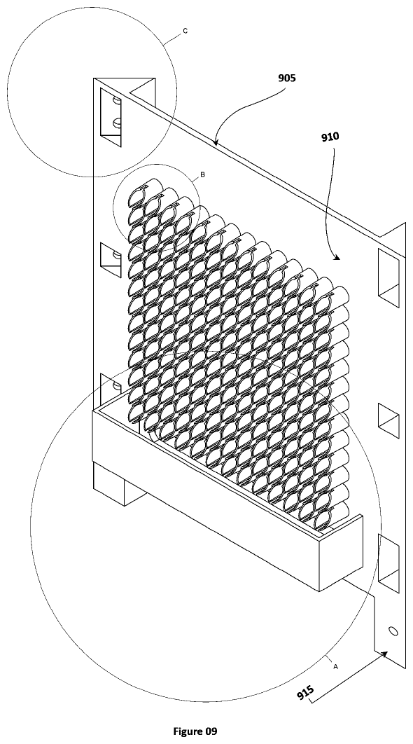

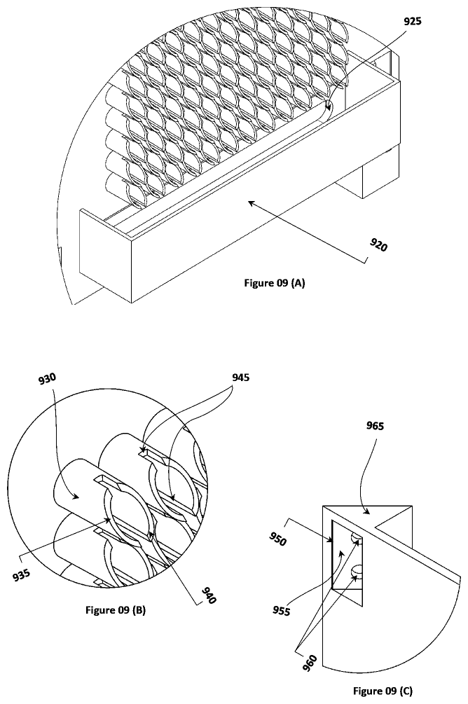

FIG. 08 depicts the exploded view 800 of a hydro aero pot 100 before assembly, wherein the exploded view 800 further depicts the sidewalls 110, base plate 120, and the reservoir tank 130 in a segmented view from top to the bottom in three layers that shows the relationship or the order of the assembly of various parts (110, 120, 130) according to the present invention.

FIG. 09 depicts the perspective front view of an external appearance of a sidewall 110, wherein FIGS. 9(A), FIG. 9(B), and FIG. 9(C) depict the detailed views of the exterior surface of the sidewall 110 with various exterior components configured therein, according to the present invention. In one embodiment, the sidewall 110 has an upper flat edge 905, and an exterior surface 910 that may partially different from the other side with a smooth surface area around the outer margin of the surface, wherein most of the components may configured in the middle and the lower areas of the exterior surface 910. The sidewall 110 may have a plurality of connection legs 915 on both lower ends by extending outwardly in a triangular prism shape beyond the perimeter of the sidewall 110.

FIG. 09(A) depicts the detailed view “A” of FIG. 09, which represents an expanded view of a collection tank 920 of the side wall 110. The collection tank 920 of the sidewall 110 is an outwardly extended embodiment with an open top and perpetually connected walls configured to form an empty space in close proximity to the lower end of the sidewall 110 for the collection of draining water. The collection tank 920 may also configure with at least one slot opening 925 inside the collection tank 920 through the lower bottom part of the sidewall 110 that may parallel to the bottom of the collection tank 920. The slot open 925 may configure to return the collected drained-off water in the collection tank 920 back to the hydro aero pot 100 through the slot open 920 made inside the collection tank 920. Preferably, the plant container may comprise at least one collection tank 920 with the object of collecting water that may take any shape or configuration, which may configure on the sidewall 110 or, alternatively on the reservoir tank 130 perpetually or, detachably connected with at least one opening 925 configured to facilitate the transfer of collected water inside the collection tank 920 back to the reservoir tank 130.

FIG. 09(B) depicts the detailed view “B” of FIG. 09, according to the present invention. FIG. 9(B) represents an expanded view of a hollow pin 930, which may characterize as an outwardly extended embodiment with a hollow inside, an aperture 940 that opens to the external environment at the independent far end, while the rear end of the hollow pin 930 attached to the sidewall 110 that opens to the internal environment of the upper chamber. The hollow pin 930, is replicate to create a porous structure that may configure in the middle area of the sidewall 110. Preferably, the hollow pins 930 substantially cover the exterior surface of the sidewall 110, which may represent as outwardly extended hollow recesses 930 with apertures 940.

As FIG. 09(B) the detailed view “B” of FIG. 09 further portrays, preferably the independent far end of the hollow pin 930 that may have an oblique cut 935, and a vertical cut 945 along the hollow pin 930 in the vertical plane up to independent far end of the aperture 940 through the oblique cut 935, on the hollow pin 935 to create a waterfall effect by breaking the water stream in the gravity fed water before coming out of the aperture 940.

FIG. 02 plan view 200 and FIG. 03 front view 300 further depict the top and side views of the hollow pin 930, which further portrays both the oblique cut 935, and the vertical cut 945, on the far end of the hollow pin 930. Alternatively, the given cuts may not necessarily be as configured, which may take any other shape or angles as well. Nonetheless, the hollow pins 930 may be extended outwardly straight, tapering, or as a downwardly extended bend at the end. In further preferred embodiment, the collection tank 920 may configure underneath the hollow pins 930 for the collection of draining water.

FIG. 09(C) depicts the detailed view “C” of FIG. 09, according to the present invention. FIG. 9(C) represents an expanded view of a connection slot 950. Preferably, the connection slot 950 may configure to each corner and may also be on the side edges of the sidewall 110, which may comprise of an angular wall 955, wherein at least one slot opening 960 configured from that angular wall 955 with an empty space inside the connection slot 950, through a beveled connection edge 965, on each connection slot 950. The interior angular wall 955 of the slot open 950 may parallel to the outside surface of the beveled connection edge 965.

Alternatively, any basic locking mechanism that is generally available to the public in the present and future configured in conjunction with porous base plate 120 and the reservoir tank 130, or any other alternative compatible locking mechanism configured to the sidewall 110, or that may work in conjunction with porous base plate 120 and the reservoir tank 130 for easy, efficient manufacturing, and stronger assembly of the hydro aero pot 100.

Alternatively, a plurality snap fit interlocking components may configure on to the same locations as given in the present illustration instead of using connection slot 950, or each corner or on side edges of the sidewall 110 as necessary to interlock sidewall 110 to the reservoir tank 130 with porous base plate 120 for the unification of embodiments in order for easy handling.

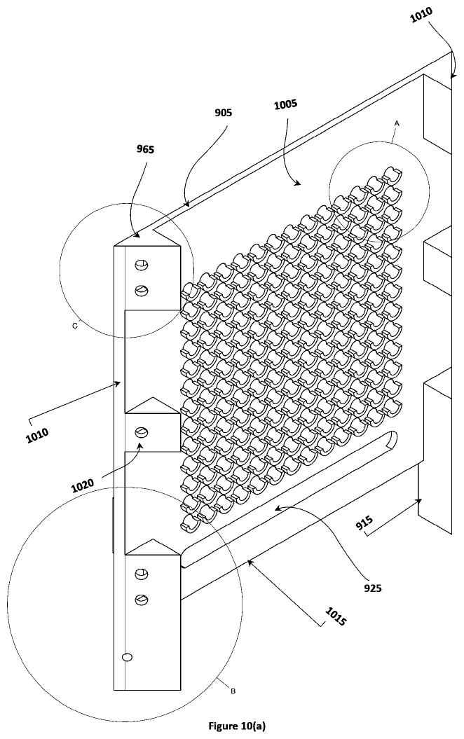

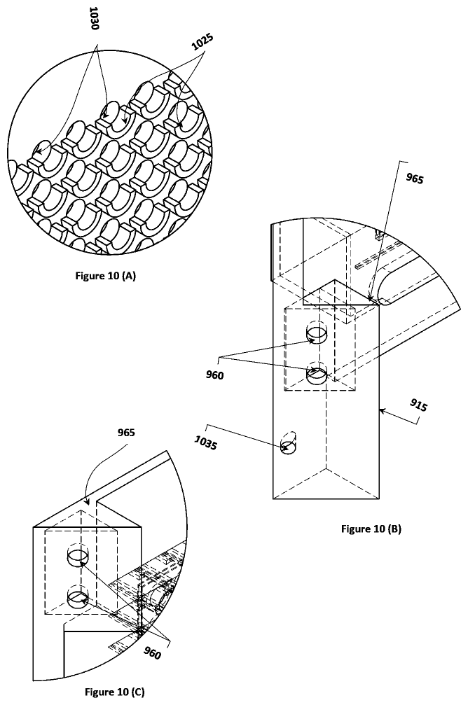

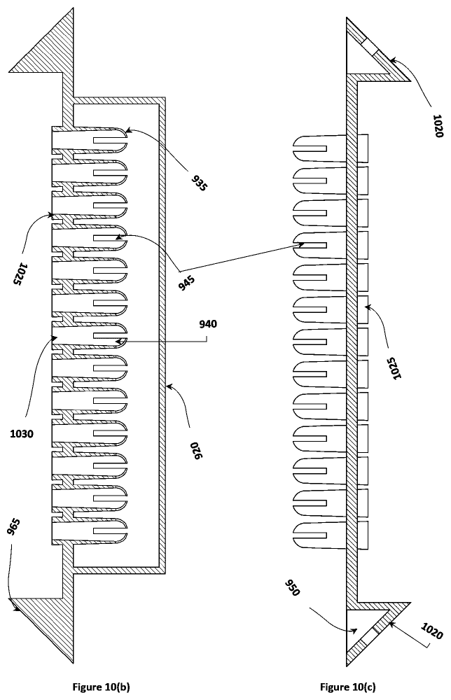

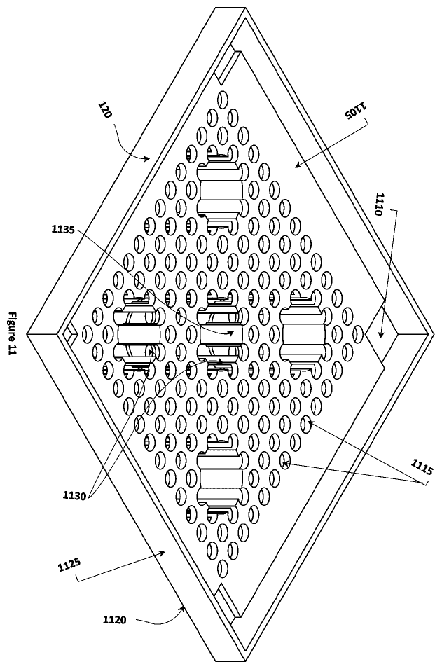

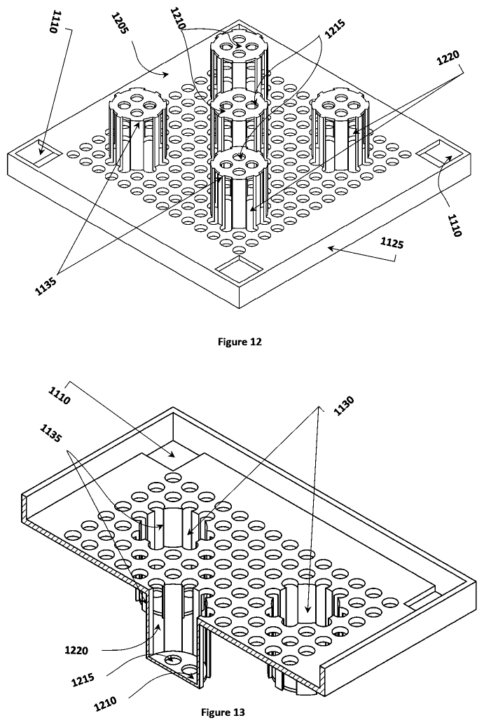

FIG. 10(a) depicts the perspective front view of an interior appearance of the sidewall 110, wherein FIG. 10(A), FIG. 10(B), and FIG. 10(C), depict the detailed views of the interior appearance of the sidewall 110 with various interior components configured therein, while FIG. 10(b) depicts a cross section of a sidewall 110 across lower end including hollow pins 930 with the collection tank 920 and FIG. 10(c) depicts a sectional view of the sidewall 110 across middle area according to the present invention. The sidewall 110 comprised of the upper edge 905, an interior surface 1005 that may partially different from exterior surface 910 with a smooth surface area around the outer margin, wherein both side edges on the left and the right of the sidewall 110 may configure as a beveled side edge 1010, and a lower flat edge 1015.

The beveled side edge 1010 may configure between the upper and lower beveled connection edge 965 with an oblique angle to the vertical plane to form the beveled side edge 1010 while configuring one or more beveled connection edge 1020 to support stronger assembly and to eliminate deformation issues at continuous reuse of the sidewall 110. Further, the beveled side edges 1010 or the beveled connection edges 965 may be formed in different ways to connect the sidewalls 110 together or completely eliminated with a perpetually connected sidewall or any other alternatives, thus given method is only an example ways of locking mechanisms.

As FIG. 10(a) further depicts, preferably the lower flat edge 1015 of the sidewall 110 may similar to the upper flat edge 905. The beveled side edge 1010 also includes the beveled connection edge 1020 on an acute angle to the vertical plane, which may similar to the beveled connection edge 965 that holds the similar components including the angular wall 955, and the slot open 960 for connectivity. Further, both faces of the left and the right beveled connection edge 1020 may position facing direct opposite angles to each other. Preferably, both beveled side edges 1010 on the right and left sides of the sidewall 110 may facing each other away to face with a replicated sidewall 110's opposite beveled side edge 1010 that may perpendicularly mounted, which may characterize by a second beveled side edge 1010 corresponding to and connected to a first beveled side edge 1010 of an adjacent sidewall 110 during the assembly.

FIG. 10(A) depicts the detailed view “A” of FIG. 10(a), which represents the expanded view of the interior surface 1005 of the sidewall 110. FIG. 10(A) portrays the interior surface 1005 of the side wall 110 preferably comprised of a plurality of gutters 1025 that may position around a plurality of apertures 1030 from the hollow pins 930 of the outer surface 905. Alternatively, FIGS. 10(b) and 10(c) further depict the sectional views of the gutters 1025, hollow pin 930, and the sectional view of apertures 1030. In use, each of the gutters 1025 may inwardly extend towards the substrate inside the upper chamber, which may be of any shape with the objective of collecting water from the substrate material, while creating air pockets underneath the gutters 1025 for air pruning of roots and also for directing the roots growing therein outwardly towards hollow pins 930 to expose to the air for air pruning.

FIG. 10(B) depicts the detailed view “B” of FIG. 10(a), which represents the expanded hidden and visible views of the left lower corner of interior surface 1005 of the sidewall 110 according to the present invention. In a preferred embodiment, the lower edges of the beveled connection edge 965 and the rear side of connection slot 950 of both ends of the sidewall 110 may extend beyond the lower flat edge outwardly in a triangular prism shape in the present example to form the connection leg 915 that may interlock with the porous base plate 120 and the underneath reservoir tank 130 during assembly. The shape of the leg may be of any shape, or may not have the connection leg 915, or which does not necessarily be as given, and the given shape was only an exemplary way may use for a strong connection between various embodiments of the present invention.

Alternatively, or in addition, as depicted in FIG. 10(B) the connection leg 915 may have a slot opening 1035, on the connection leg 915 to tie up with the reservoir tank 130 strongly through the porous base plate 120, in order to make assembly more convenient for the user as well as to make it a single piece of utensil while on the operation. The broken lines portray the prism-shaped empty space and the slot openings 960 that may make from the angular wall 955 inside the connection slot 950 through to the beveled connection edge 965.

FIG. 10(C) depicts the detailed view “C” of FIG. 10(a), which represents the expanded hidden and visible views of the top left corner of the connection slot 950 from behind in the interior surface 1005 of the sidewall 110 according to the present invention. As portrayed in FIG. 10(C), the continuous lines represent the appearance of the back of the connection slot. The broken lines portray the prism-shaped empty space and the slot openings 960 that may make from the angular wall 955 inside the connection slot 950 through the wider ends of the beveled connection edge 965.

FIG. 10(b) depicts a cross section of the sidewall 110 across the lower end comprising the multitude of hollow pins 930 with the collection tank 920, which illustrates the oblique cut 935, on the aperture 940 and the vertical cut 945 across on vertical plane. Further, the gutters 1025 and the aperture 1030 at the rear end of the hollow pin 930 of the sidewall 110. In addition, FIG. 10(c) further depicts another sectional view across connection slot 950 on the beveled side edge 1010 of the sidewall 110 according to the present invention. Preferably, depicting the configuration of the angular wall 955 with slot open 960, inside connection slot 950.

FIG. 11 depicts the perspective front view of an external appearance of the porous base plate 120 with various components configured therein according to the present invention. The porous base plate 120 preferably includes a compact surface 1105 around the porous area of the base plate 120.

Preferably, each corner of the porous base plate 120 includes a slot opening 1110 as depicted in FIG. 11, which provides an opening for sidewall legs 915 to intersect through the porous base plate 120 that allows a stronger assembly of the upper chamber of the hydro aero pot 100 and cross-connected to the reservoir tank 130 below. The shape of the slot opening 1110 may correspond to the connection leg 915. Alternatively, the locking mechanism may not necessarily be the same as in the given example, which may be of any generally available locking mechanism or, certain embodiments may perpetually interconnect or, a snap fit locking mechanism that provides stronger connectivity, easy assembly, and be able to use as a single unit.

In a further preferred embodiment, the porous base plate 120 also includes a plurality of apertures 1115 on the middle area to create porosity on the surface of the base plate as portrayed in FIG. 11. Preferably, the multitude of apertures 1115 in the porous area of the base plate 120 act as an air barrier to the roots as they air pruned when reaching out of the porous base plate 120, which further improves the air pruning of the roots that reach out of the base plate by increasing the number of lateral root growth that promotes the creation of the multitude of lateral roots through the abatement of apical dominance.

In a preferred embodiment as depicted in FIG. 11, the compact inner surface 1105 is widened up to configure an exterior edge 1120 of the porous base plate 120, which may extend upwardly as a short periphery wall 1125 around the periphery of the porous base plate 120 with an appropriate thickness to hold side walls 110 tightened together.

Preferably, the porous base plate 120 also may include one or more downwardly extended porous hollow cup 1130 with a cup wall 1135 up to the edge of the water level of the reservoir tank 130, which may alternatively act as a self-watering embodiment due to the capillary action of the water through substrate filled in the porous hollow cup 1130. Further, the roots extend beyond the porous hollow cup 1130, may enter the reservoir tank 130, and act as hydroponic roots while providing continuous nutrient and water supply to the plant throughout the life cycle.

FIG. 12 depicts the perspective back view of an external appearance of the porous base plate 120 with porous hollow cup 1130 configured therein according to the present invention. The back side of the porous base plate 120 preferably includes a compact rear surface 1205 similar to the top outer surface 1105 around the porous area of the base plate 120 for strength as well as for holding the substrate compacted near sidewalls.

As FIG. 12 further depicts, the porous hollow cup 1130 has a porous bottom 1210 with a plurality of apertures 1215 for the porosity of the cup bottom 1210, which helps the roots to reach the water in the reservoir tank 130 and to initiate the capillary action of the substrate. Preferably, the porous hollow cup 1130 may also have a plurality of vertical openings 1220 on the cup wall 1135 for the further penetration of roots towards the water by the sides of the cup wall 1135, which may also help to increase the capillary action further.

Preferably, FIG. 13 depicts the perspective sectional view of the porous base plate 120 with porous hollow cup 1130 configured therein according to the present invention, which further portrays the porous bottom 1210 with the plurality of apertures 1215 for the porosity of the cup bottom.

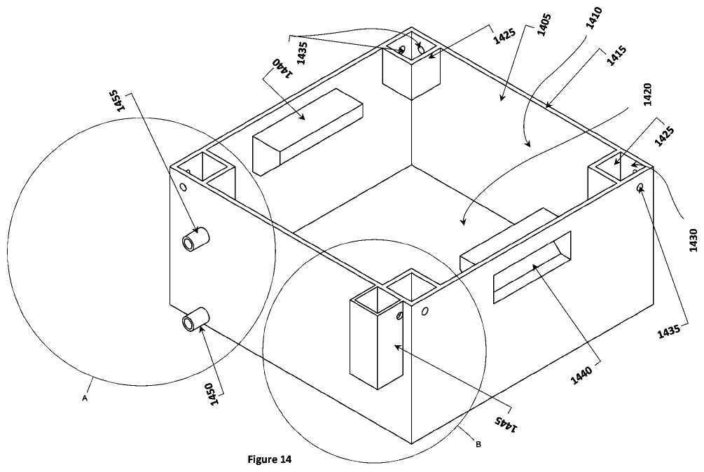

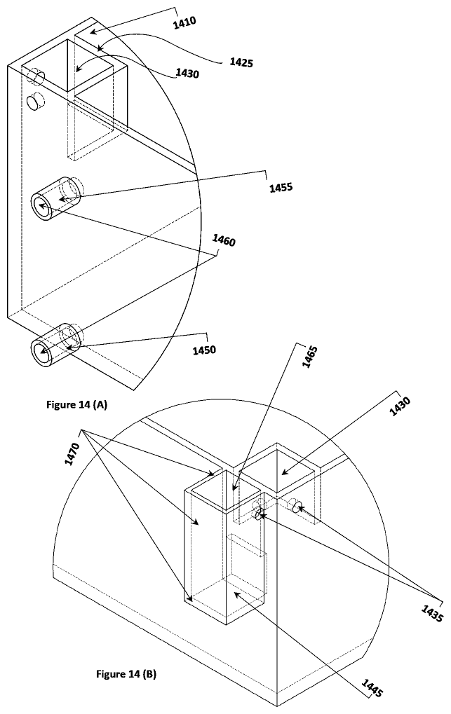

FIG. 14 depicts the perspective front view of the reservoir tank 130, wherein FIG. 14 (A), FIG. 14(B), and FIG. 14(C) depict the detailed views of the various exterior and interior components “A”, “B” and “C” marked therein according to the present invention. As FIG. 14 portrays in a further embodiment, the reservoir tank 130 of the present invention comprised of an open top 1405, a plurality of sidewalls 1410, a continuous top edge 1415, and a compact bottom 1420 perpetually connected to form a water storage for the continuous use of the plant growing in the upper chamber.

In a further preferred embodiment, the plurality of sidewalls 1410 and continuous top edge 1415 may connect from the inside surface of the sidewalls 1410 by extending an alternative short wall 1425 as a protuberance towards the interior of the reservoir tank 130 as portrayed in FIG. 14(B) with broken lines to create a plurality of snap fit opening 1430 in each corner of the reservoir tank 130 to interlock with the upper chamber of the hydro aero pot 100 as depicted in FIG. 14(A) of the present invention. The internal shape of the snap fit embodiments 1430 may correspond to the sidewall leg 915 for proper assembly. Alternatively, any generally available locking mechanism or a combination of different locking mechanisms may configure in conjunction with sidewalls 110 and the porous base plate 120, which may comprise snap fits, latches, clamps, slot locks, slide locks, thread locks, joints, etc. without limiting to the scope of the present invention.

Preferably in one embodiment, each corner of the reservoir tank 130 may include a plurality of slot openings 1435 on sidewalls 1410 as depicted in FIG. 14 and FIG. 14(B), which provides an opening to fasten the connection legs 915 using a zip tie/cable tie 140 through the slot opening 1110 of the porous base plate 120 that allows a stronger assembly of the upper chamber of the hydro aero pot 100 and cross-connected to the reservoir tank 130.

preferably in another embodiment, FIG. 14 also depicts a pair of inwardly extended handles 1440 that may embed into the corresponding opposite sidewalls 1410 of the reservoir tank 130, in close proximity to the upper edge 1415 for the prime grip, handling, and moving of the hydro aero pot 100. Alternatively, the handles 1440 may configure into any appropriate surface and they may be of any shape and configuration, instead of embedded handles 1440 in the given example that may also be a slot opening in the same locations or, any similar alternative surfaces with any shape and a convenient handling surface for a prime grip.

Preferably, FIG. 14 and FIG. 14(B) depict a test port 1445 in detail, which is an outwardly extended vertically aligned embodiment with an open top 1465, at least one wall 1470 forming sides, and a compact bottom.

In further preferred embodiments, as depicted in FIGS. 14 and 14(A), the reservoir tank 120 comprised of a drainage nipple 1450 and an overflow nipple 1455 on the front face of the reservoir tank 130 with each of them having a hollow interior and an aperture 1460 for the flowing water out of the reservoir tank 130. The drainage nipple 1450 and the overflow nipple 1455 may be an ordinary tube with a hole that may be plugged with a stopper, or they may comprise a tube or nipple trap extending outwardly from the sidewall 1410 of reservoir tank 130, which may be clamped, capped or closed by any other means, to control the outflow of water from the reservoir tank 130, where the openings may also be detachably connected to the exterior drainage tubes for removal of excess water away from the reservoir tank 130 into a collection vessel.

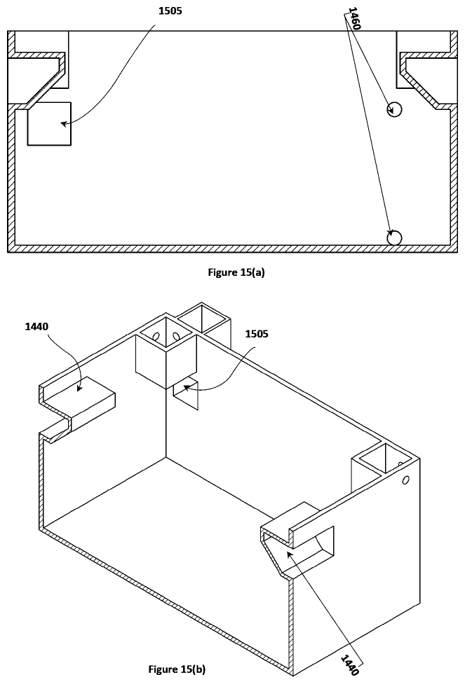

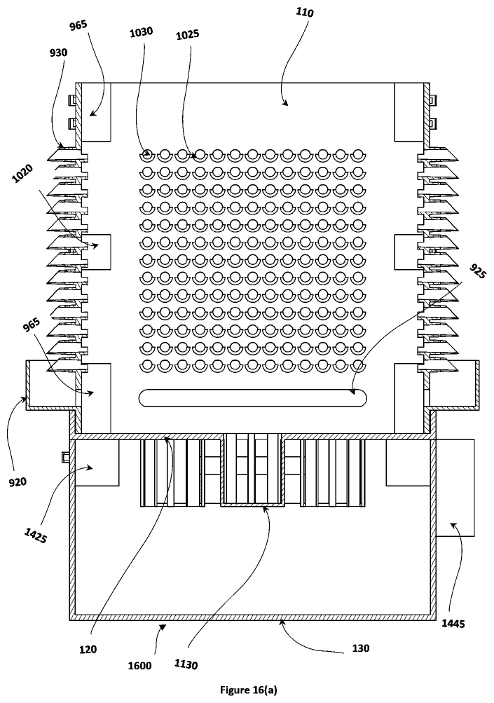

As depicted in FIGS. 15(a) and 15(b) sectional views of the test port 1445 may include a slot opening 1505 through the side wall 1410 of the reservoir tank 130 on the lower end of the test port 1445 to keep the water connectivity to the reservoir tank 130 uninterrupted.

In a further preferred embodiment, as portrayed in FIG. 15(a) and FIG. 15(b) sectional views, drainage nipple 1450 and the overflow nipple 1455 open to the reservoir tank 130 with the same aperture 1460 for each nipple as portrayed in FIG. 15(a). The drain off nipple 1450 may use to maintain the water quality of the container which allows easy drain-off ability, if the water is polluted, or contaminated. Alternatively, or in addition, overflow nipple 1455 may keep the water level constant without direct contact of the water, with the lower part of the upper chamber except for the porous hollow cup 1130 on the porous base plate 120 to promote capillary action and hydroponic root growth.

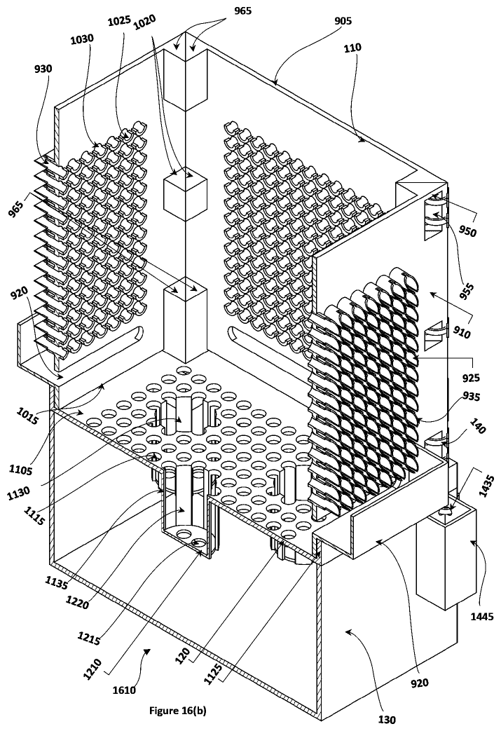

FIG. 16(a) and FIG. 16(b) depict the sectional front view and the sectional perspective front view of the assembled hydro aero pot 100 according to the present invention. Both drawings portray the sectional view of the assembled hydro aero pot 100 in order to illustrate how various components of the provided embodiments may fit together once assembled, and positioned inside the hydro aero pot 100 of the given example. As all the provided numerals are already explained in the previously referenced drawings, only the necessary explanations are provided below with the sectional views.

Preferably, the porous base plate 120 is mounted on top of the reservoir tank 130, wherein the assembled upper chamber of the hydro aero pot 100 is mounted on top of the porous base plate 120. The reservoir tank 130 may have the same dimensions as the porous base plate 120, wherein the connection legs 915 may be cross-connected through slot openings 1110 of the base plate 120 to the reservoir tank 130. Further, the snap fit embodiments 1425 provided on each corner of the upper edge 1415 of the reservoir tank 130 may force against the sidewall legs 915 that may manually push to crossover the porous base plate 120 into the empty space 1430 of the snap fit features 1425 of the reservoir tank 130.

The connection legs 915 may zip/cable tied 140 through the provided slot opening 1435 on each corner of the reservoir tank 130 to hold them together as a single unit. Preferably, the sidewalls 110 of the upper chamber of the hydro aero pot 100 may also tie up together using the zip/cable ties 140 through the slot openings 960 provided on the sidewall 110 for stronger assembly and rugged use. The slot openings 920 of the sidewall 110, portray the connection through the collection tank 920 of the sidewall 110. Further, the assembly of porous base plate 120 with sidewalls 110 and the reservoir tank 130 portrays the connection and position after their assembly.

The mounting components configured on the hydro aero pot 100 permit vertical mounting of the lower and upper chambers, which may engageable with each other to permit proper fastening between the connection leg 930 and the slot opening 1035 therein of the sidewall 110 that may align with the slot openings 1435 of the reservoir tank 130 to tie them up together using a generally available zip/cable tie 140.

According to the present invention, the gravity-fed water may collect in the reservoir tank 130, which may aerate while descending through the hollow pins 930 of sidewall 110 or through the substrate that may enrich water-soluble nutrients and oxygen, thus providing an uninterrupted supply of major nutrients and water from the extended root system inside the reservoir tank 130. The aeration may take place due to the waterfall effect in the sidewalls 110 or through the substrate that enriches oxygen content in the water, which minimizes the degradation of submerged roots inside the storage tank 130 due to higher oxygen levels that promote the submerged root growth uninterrupted. Alternatively, the reservoir tank 130, or the incoming water may be aerated by external means to further increase the oxygen content in the water.

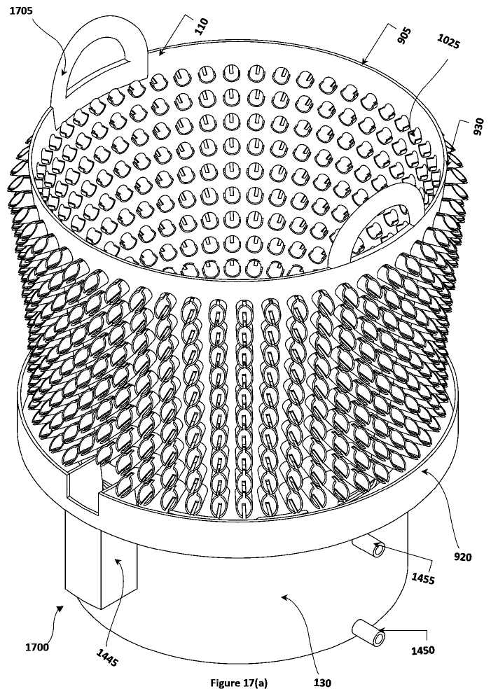

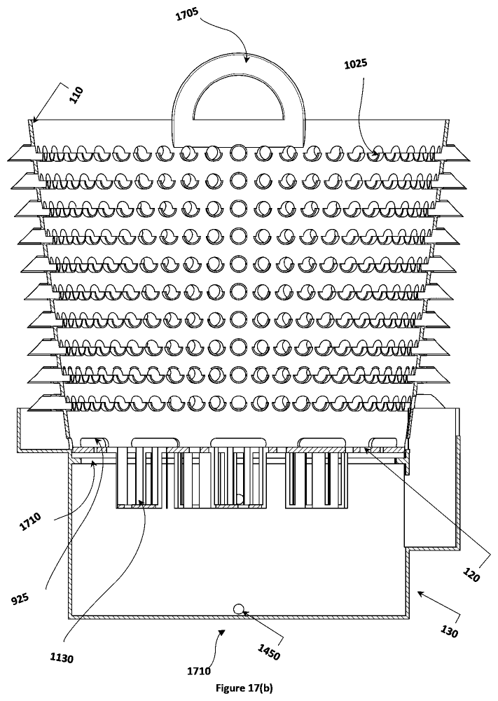

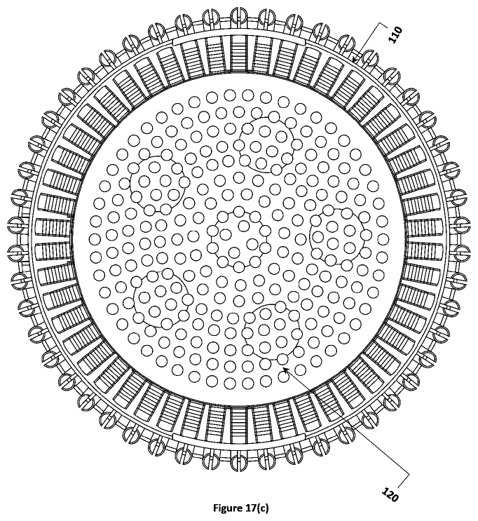

FIG. 17(a), FIG. 17(b) and FIG. 17(c) depict the perspective front view, the sectional view and the plan view of an example hydro aero pot 100 with a perpetually connected sidewall 110 to the reservoir tank 130, and a detachable porous base plate 120 according to the present invention, which further illustrates the different way of configuring the same hydro aero pot 100. FIG. 17(a) portrays the perspective front view 1700 of the assembled hydro aero pot 100 in order to illustrate how various components of the provided embodiments may fit together with a single sidewall 110, characterized by a perpetually connected reservoir tank 130 with a detachable porous base plate 120 positioned inside as illustrated in FIG. 17(c) of the hydro aero pot 100 as of the given example. Since, most of the provided numerals are already explained in the previously referenced drawings, only the necessary explanations are provided below with the given views. As FIG. 17(a) illustrates, the sidewall 110 is characterized by a fair of handles 1705, the open top 905, the collection tank 920, the hollow pin 930, the plurality of gutters 1025, the test port 1445, drain off nipple 1450, overflow nipple 1455, and the apertures 1460 of the hydro aero pot 100, whereas FIG. 17(b) sectional view and the FIG. 17(c) illustrate the porous base plate 120 characterized by porous hollow cups 1130, with the plurality of apertures 1115, sit on a ledge lock 1705, which is a protuberance configured on the top edge of the reservoir tank 130 of the hydro aero pot 100.

An object of the present invention is to provide an improved plant container for growing a plant intended to be root washed throughout the life cycle for the removal of excess fertilizer or added chemicals whereby collection and accumulation of leached such chemicals may be prevented, collected, and removed for recycling and reuse in an industrial application. Preferably, the object may achieve by the using of continuous water inflow through the upper chamber of the hydro aero pot 100 that accumulate the excess water inflow inside the reservoir tank 130, which may be removed continuously through the overflow nipple 1450 and the drain off nipple 1445 until the required water quality is achieved.

The invention has been described in terms of particular embodiments. The alternatives described herein are examples for illustration only and may not to limit the alternatives in any way. Certain steps of the invention may be performed in different shapes and still achieve the desirable results. It will be obvious to persons skilled in the art to make various changes and modifications to the invention described herein. To the extent that these variations depart from the scope and spirit of what is described herein, they are intended to be encompassed therein. It will be understood by those skilled in the art that various changes in form and details may be made therein without departing from the scope of the invention encompassed by the appended claims.

What is claimed is:

1. A hybrid plant container assembly comprising:
at least one sidewall characterized by a plurality of hollow pins, and a collection tank configured underneath the hollow pins with at least one opening inside the collection tank; and,
a porous base plate characterized by a plurality of apertures, and at least one downwardly extended porous hollow cup;
mounted on,
a reservoir tank characterized by a test port, configured to a sidewall of the reservoir tank;
for growing horticultural plants.

2. The plant container assembly of claim 1, the plant container may alternatively configure with perpetually connected sidewalls to the reservoir tank with the detachable porous base plate or;
alternatively, the sidewalls may be detachable from the reservoir tank or the sidewall.

3. The plant container assembly of claim 1, comprising:
the four sidewalls, each configured with two connection legs, perpendicularly mounted, which may characterize by a second beveled side edge corresponding to and connected to a first beveled side edge of an adjacent sidewall on top of the porous base plate;
configured to mount on top of the reservoir tank for growing horticultural plants.

4. The plant container assembly of claim 1, the sidewall further comprising:
an upper edge, a lower edge, the exterior surface, an interior surface, the side edges characterized by any suitable interlocking components, or a beveled side edge configured to the right and left sides of the sidewall.

5. The plant container assembly of claim 1, the sidewall further comprising:
the plurality of hollow pins characterized by an oblique cut, and a vertical cut on an aperture configured on the independent far end, with a gutter configured to the posterior end of an aperture on the interior surface of the sidewall, and at least one connection leg characterized by a slot opening, or;
alternatively, the given cuts may not necessarily be as characterized, which may take any other shapes as well, and the hollow pins 930 may be extended outwardly straight, tapering, or as a downwardly extended bend at the end.

6. The plant container assembly of claim 1, the sidewall further comprising:
a basic locking mechanism configured to each corner or on side edges of the sidewall, or any other alternatives that may comprise snap fits, latches, clamps, slot locks, slide locks, thread locks, joints, etc., or a combination of generally available locking mechanisms configured to assemble the sidewalls, porous base plate and the reservoir tank without limiting to the scope of the present invention or;
alternatively, a plurality of inwardly opened connection slot openings, configured on each corner of the exterior surface of the sidewall, characterized by an angular wall, wherein at least one slot opening made from said angular wall through the beveled connection edge, on each connection slot for stronger connectivity between sidewalls or;
alternatively, a basic snap fit locking mechanism may configure to each side edge of the sidewall with at least one snap fit (male) device in one side edge, while the corresponding snap fit (female) device configured to the corresponding side edge for stronger assembly of the sidewalls.

7. The plant container assembly of claim 1, the sidewall further comprising:
each of the gutters may inwardly extend towards the substrate inside the upper chamber that may be of any shape with the objective of collecting water from the substrate material while creating air pockets underneath the gutters for air pruning of roots.

8. The plant container assembly of claim 1, the plant container may comprise at least one collection tank with an open top, and perpetually connected walls or, at least one wall that may take any shape or configuration to form an empty space with the object of collecting the draining water, underneath the hollow pins, and in close proximity to the lower end of the sidewall, and the collection tank may configure on the sidewall or, alternatively on the reservoir tank perpetually or, detachably connected with at least one opening configured to facilitate the transfer of collected water back to the reservoir tank.

9. The plant container assembly of claim 1, the porous base plate comprising:
the porous hollow cup configured with a cup wall, a porous bottom with a plurality of apertures, and the cup wall may include a plurality of openings for further penetration of roots towards the water through the sides of the cup wall in addition to the porous bottom.

10. The plant container assembly of claim 8, the porous base plate comprising:
the porous hollow cup may alternatively act as a self-watering embodiment due to the capillary action of the water through the substrate filled inside the porous hollow cup.

11. The plant container assembly of claim 1, the porous base plate further comprising:
a basic connectivity mechanism configured for stronger and easy assembly that may connect the upper chamber to the reservoir tank, which may configure with any assisting components, or by any other means, not limiting to the scope of the present invention or;
alternatively, a plurality of slot openings on each corner for receiving connection legs during assembly, with a solid surface around the porous area and a periphery wall around the porous base plate for stronger assembly.

12. The plant container assembly of claim 1, the reservoir tank further comprising:
an open top, at least one sidewall, a compact bottom, and the test port for water testing with a basic locking mechanism configured to the open top edge of the reservoir tank for the ease of assembly with the upper chamber of the plant container or;
alternatively, the reservoir tank may comprise of a perpetually attached or threaded sidewall and the collection tank, wherein the porous base plate may be detachable with a generally available locking mechanism.

13. The plant container assembly of claim 1, the reservoir tank further comprising:
at least one sidewall, the compact bottom, the test port for water testing, a drain off nipple, and an overflow nipple with an aperture on each nipple to be connected to external collection lines for removal of excess water.

14. The plant container assembly of claim 1, the reservoir tank further comprising:
a plurality of snap fit devices configured on each corner with an opening to interlock with the upper chamber of the pot, a plurality of slot openings close to each corner of the open top may configure for connectivity with sidewall connection leg or;
alternatively, any basic locking mechanism configured in conjunction with sidewalls, porous base plate, and the reservoir tank for stronger assembly.

15. The plant container assembly of claim 1, the reservoir tank further comprising:
the test port may configure on one corner of the outer perimeter of the top edge to use for manual, automated, or remote monitoring as appropriate with externally mounted devices, which may comprise of an open top, at least one wall forming sides, and a compact bottom, with a slot opening through the reservoir tank sidewall configured on the lower end of the test port to keep the water connectivity uninterrupted.

16. The plant container assembly of claim 15, the reservoir tank further comprising:
alternatively or in addition, one or more sensors or any other appropriate devices may configure to mount on the test port that may connect to a computer system for automated or remote monitoring, which may measure data including: water or aqueous nutrient solution's oxygen availability, nutrient levels/electrical conductivity, pH level, temperature, barometric pressure, light levels, humidity, carbon dioxide levels, a liquid level in the water storage and store the data on the computing system, wherein the computing system monitors the sensors, and communicates the stored data to a computing device and generate alerts.

17. The plant container assembly of claim 1, the reservoir tank further comprising:
a fair of handles, which may embed to the corresponding opposite walls of the reservoir tank, or alternatively to the sidewall as appropriate, for convenient handling of the plant container, which may be embedded, externally attached, or a simple slot open with any shape that is generally available for the use, or that may be configured in the future without any limitation and particularly based on the manufacturing and usage preferences.

18. A method for substrate and root washing comprising:
the drain off nipple and the overflow nipple with the apertures on each nipple that connected to the external collection lines, may use for substrate and root washing with a regulated water inflow to the upper chamber of the plant container assembly and continuous outflow through drain off and overflow nipples of the reservoir tank for the removal of excess fertilizer or added chemicals, whereby collection and accumulation of such chemicals may prevent, collected, and removed for recycling and reuse.

19. The plant container of claim 1, the container assembly may mainly be made of recycled plastic materials for sustainability, but virgin plastic, wood, clay, ceramic, forms, etc., or any other appropriate material, may substitute as appropriate.

20. A hybrid plant container assembly comprising:
at least one upwardly extended sidewall characterized by a plurality of recesses, a plurality of apertures, and a collection tank configured underneath the recesses with at least one opening inside the collection tank;
perpetually or detachably mounted on,
a reservoir tank characterized by a test port, configured to a sidewall of the reservoir tank; and,
a detachable porous base plate characterized by a plurality of apertures, and at least one downwardly extended porous hollow cup;
for growing horticultural plants.

21. The plant container assembly of claim 20, plant container assembly comprising:
any of the claims 2 to 19 as appropriate.
